(19) United States
(12) Patent Application Publication
(10) Pub. No.: US 2008/0025581 A1
(43) Pub. Date: Jan. 31, 2008

(54) Apparatus for fingerprint identification

(75) Inventor: Yu-Jen Chen, Taipei City (TW)

Correspondence Address: BIRCH STEWART KOLASCH & BIRCH, PO BOX 747, FALLS CHURCH, VA, 22040-0747, US

(73) Assignee: ARACHNOID BIOMETRICS IDENTIFICATION GROUP CORP.

(21) Appl. No.: 11/583,935

(22) Filed: Oct. 20, 2006

(30) Foreign Application Priority Data
Jul. 28, 2006 (TW) 095213375

(51) Int. Cl. G06K 9/00

(52) U.S. Cl. 382/124

(57) ABSTRACT

A structure for fingerpint includes a main body, a sliding path, a bulge portion, a slot and a sliding fingerprint sensor. The sliding path is formed on a surface of the main body. The bulge portion is disposed on the sliding path. The slot is disposed on a top of the bulge portion for providing the bulge portion a first cambered surface and a second cambered surface corresponding to each other. The fingerprint sensor is disposed between the first cambered surface and the second cambered surface of the slot. The structure of the present invention increases the efficiency of the fingerprint sensor in capturing the fingerprint using an existing software efficiency and area of the fingerprint sensor. Moreover, the structure decreases the failure rate in capturing the fingerprint.

### BACKGROUND OF THE INVENTION

1. Field of the Invention

The present invention relates to an apparatus for fingerprint identification capable of capturing a fingerprint image, and in particular to a sliding or continuous fingerprint identification apparatus.

2. Description of the Prior Art

The advantage of utilizing biometric recognition technology for personal identification is that characteristic personal biometric data can be acquired from part of the human body, and used at any time. Not only is it unnecessary for the user to intentionally memorize personal biometric data, but it is also not possible for such data to be stolen. In particular, security based on fingerprint identification is not only rigorous, since an individual fingerprint is unique, but it is also relatively convenient for use in many applications. Therefore, electronic information products with fingerprint identification security, in particular, products with a facility for protecting stored multi-media data, have evolved and have now become important.

In general, a fingerprint identification device is equipped with a fingerprint sensor, by which the characteristic of the fingerprint can be read by the fingerprint sensor when a user puts his/her fingers on a scanning surface of the fingerprint sensor. The fingerprint sensor can be in a form of an optical, pressing, sliding or continuous contact sensor, of which the optical fingerprint sensor has the highest reading efficiency. However, taking cost and space into consideration, the sliding fingerprint sensor is the most widely used in the market. The method of using the sliding fingerprint sensor relies on the fact that the fingerprint on the first section of the finger should correctly and uniformly press against and slide over the fingerprint sensor. After the fingerprint sensor acquires the fingerprint, the fingerprint is converted into a fingerprint image by an algorithm and compared with a database of the stored fingerprint data.

However, when the user incorrectly slides his/her finger or the guide path is badly designed, the finger is often compressed to generate deformation. Alternatively, when the finger does not abut against the fingerprint sensor well, the characteristic of the fingerprint may not be sufficiently captured. As a result, when the acquired fingerprint is compared with the database of the stored fingerprint data, the comparison may fail and thus it cannot be used for identifying the user. Therefore, the user has to continually keep sliding his/her finger on the fingerprint sensor, which is inconvenient in use. Thus, in order to improve the capture efficiency of the hardware of the fingerprint identification device but without increasing the area and cost of the fingerprint sensor for a given software efficiency, it is very important to improve and obtain a higher fingerprint identification ratio to satisfy the different features of the general population of users. It is desirable for the apparatus to be compatible with at least 80% of users, in accordance with the Pareto Principle (also known as the 80/20 Rule).

An object of the present invention is to overcome or alleviate at least some the drawbacks of the prior art.

### SUMMARY OF THE INVENTION

The capture efficiency of the fingerprint sensor of the present invention is improved and the failure rate in acquiring the fingerprint is reduced. Moreover, the design of the present invention is compatible with a wide range of users, without requiring any change in software design or an increase in the area of the fingerprint sensor.

In order to achieve the above objects, the present invention provides a structure for fingerprint identification, which comprises a main body, a sliding path formed on a surface of the main body, a bulge portion protruding on the sliding path, a slot provided on a top end of the bulge portion and having a first cambered surface and a second cambered surface corresponding to each other, and a sliding fingerprint sensor disposed between the first and second cambered surfaces of the slot.

With the design of the bulge portion, the present invention can improve the efficiency of the fingerprint sensor in capturing fingerprints and reduce the failure rate in capturing the fingerprints for a given software efficiency. Further, the present invention satisfies the different using features of the general population of users, by which it is not necessary to change the software design or increase the area of the fingerprint sensor, thereby reducing costs.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of the present invention;

FIG. 2 is a longitudinal cross-sectional view of the present invention;

FIG. 3A is the first schematic longitudinal cross-sectional view showing the operation of the present invention;

FIG. 3B is the second schematic view showing the operation of the present invention;

FIG. 3C is the third schematic view showing the operation of the present invention;

FIG. 3D is an enlarged longitudinal cross-sectional view of the raised portion of the guide path showing the operation of the present invention;

FIG. 4 is a perspective view of a variant of the present invention;

FIG. 5 is a perspective view of a further variant of the present invention; and

FIG. 6 is a perspective view of a further variant of the present invention.

### DETAILED DESCRIPTION OF THE INVENTION

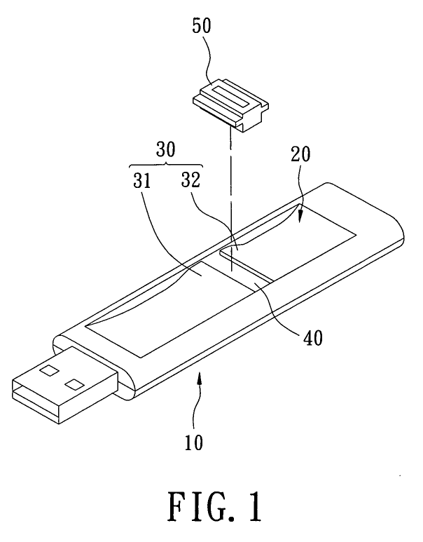

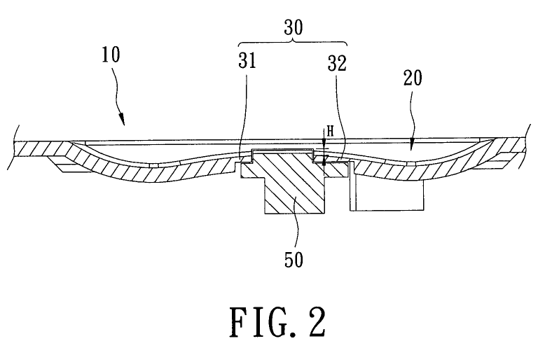

With reference to FIG. 1 and FIG. 2, the present invention provides an apparatus for fingerprint identification which comprises a main body 10. The main body 10 can be an electronic information product or simply a casing, for example. The electronic information product can be a notebook computer, mouse, MP3 player, flash drive, external mobile device such as portable hard disk, fingerprint reader or computer peripheral, for example. In the present embodiment, an electronic information product such as flash drive is used as an example.

The surface of the main body 10 is provided with an elongate and downwardly recessed guide path 20 along which the user's finger can slide. The left and right ends of the guide path serve as a starting end and a terminating end. The center of the guide path 20 protrudes upwardly to form a raised portion 30 of arcuate profile. The top of the raised portion 30 is provided with a slot 40, so that the raised portion 30 has a first convex surface 31 and a second similar convex surface 32 which are symmetrically disposed and define transition portions of the guide path which slope upwardly towards the raised portion. A sliding fingerprint sensor 50 is disposed within the slot 40 and between the first surface 31 and the second surface 32. The fingerprint sensor 50 is electrically connected with a circuit board (not shown) in the main body 10, thereby to actuate the fingerprint sensor 50.

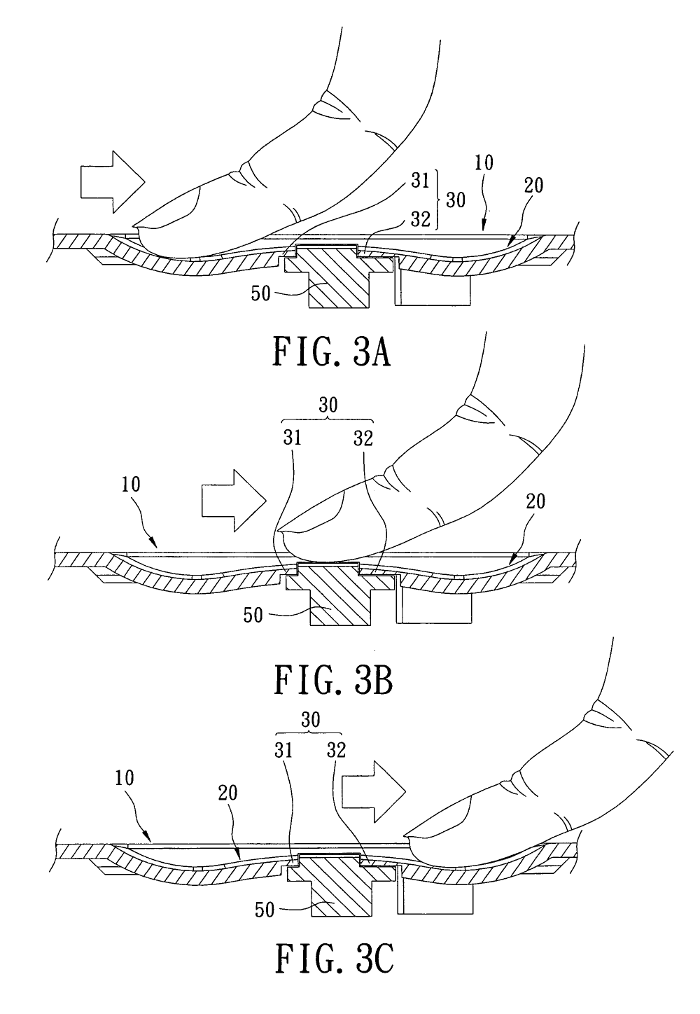

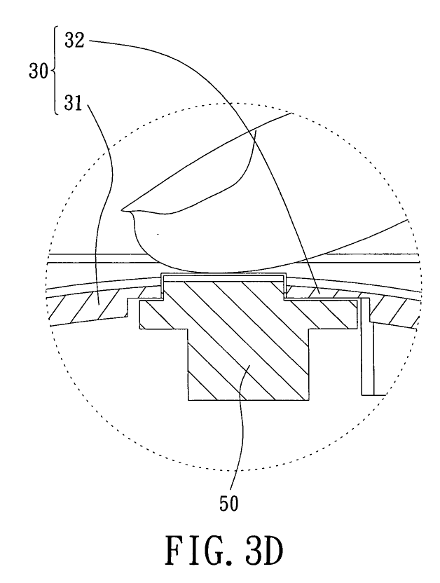

According to the above, with reference to FIGS. 3A to 3C, when a user presses the starting end of the guide path 20 with his/her first (distal) section of the finger and starts to slide it toward the fingerprint sensor 50, under the guidance of the guide path 20, this part of the finger can naturally rest against the guide path 20 and ride over the upwardly protruding raised portion 30. The finger of the user naturally contacts the first convex surface 31 of the raised portion 30, so that the finger slides upwardly and forwardly across the fingerprint sensor 50 which captures the fingerprint of the user. Thereafter, the finger slides downwardly and forwardly along the second convex surface 32, away from the fingerprint sensor 50, toward the end of the guide path 20. In this way, with the upwardly protruding raised portion 30, the finger of the user can naturally abut against the first and second convex surfaces 31, 32, thereby to avoid incorrect sliding and contacting, or insufficient contact of the finger. Therefore, the accuracy of identification of the fingerprint sensor 50 can be improved.

Further, with reference to FIG. 3D and also FIG. 3A and FIG. 3B, when the user conventionally uses a fingerprint sensor 50 to acquire the fingerprint, the finger substantially abuts against the fingerprint sensor 50 in planar contact therewith and slides over the sensor. However, the planar contact may cause excessive or insufficient capture of the fingerprint so as to increase the failure rate in acquisition. In the described embodiment of the present invention, when the distal section of the user's finger slides on the first convex surface 31 in a linear contact and rides over the fingerprint sensor 50. With the linear contact, the excessive or insufficient capture of the fingerprint characteristics can be avoided, thereby to reduce the failure rate in fingerprint acquisition.

With reference to FIG. 2 again, the height H of the fingerprint sensor 50 can be slightly greater than that of the raised portion 30 so that it can protrude slightly, thereby to increase the contact pressure between the finger and the fingerprint sensor 50.

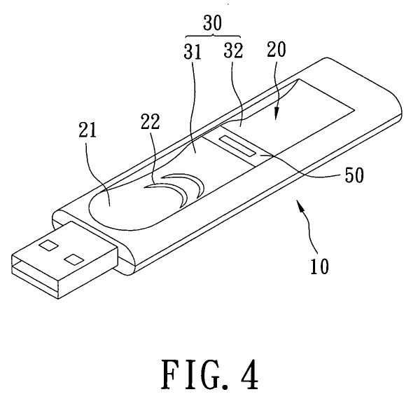

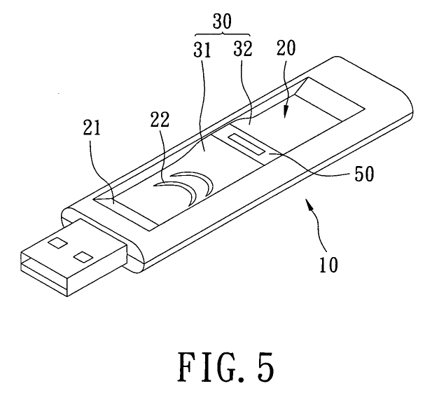

With reference to FIGS. 4 and 5, an ascending surface 21 is formed between one end or both ends of the guide path 20 and the main body 10, that is, located at an end opposite to the raised portion 30. The ascending surface 21 can be formed into a convex profile or inclined surface to serve as the starting end or terminating end. With this arrangement, the finger of the user can naturally abut against the surface of the guide path 20, thereby to increase the efficiency of the fingerprint sensor 50 in capturing fingerprints. Further, the guide path 20 in this variant is provided with a downwardly recessed trough 22 formed into a V or U shape (in plan view). The shape of the trough is not limited thereto. The drawings show two troughs, purely by way of illustration, which can be used to scrape off the sweat or dirt on the finger of the user and then will be able to increase the efficiency of the fingerprint sensor 50 in acquiring fingerprints.

In addition, with reference to FIG. 4, the transition between the outer periphery of the ascending surface 21 and the main body 10 can be further designed into a semi-circular shape in plan view to conform to the cambered profile of the front end of the first section of the finger, thereby to allow the finger of the user to be pressed into intimate contact with the surface of the guide path 20.

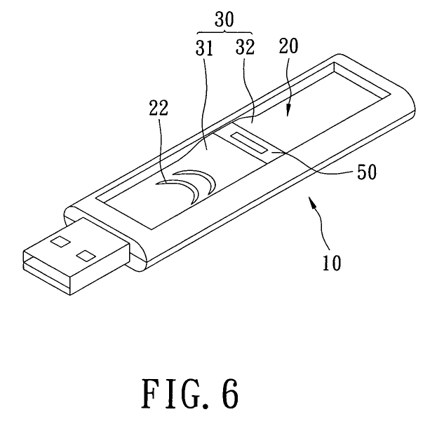

Further, as shown in FIG. 6, one end or both ends of the guide path 20 can be planar and connected to the bottom of the first and second convex surfaces 31, 32 of the transition portions. That is to say, the guide path 20 can be formed into a plane, thereby to achieve the object of increasing the capture efficiency of the fingerprint sensor 50.

Specifically, the guide path 20, the raised portion 30 and the ascending surface 21 can be integrally formed with the outer casing of the main body 10. When the user intends to actuate the electronic product or inputs his fingerprint data to access encrypted data within the electronic product, with the fingerprint characteristics of the user acquired by the fingerprint sensor 50, the encrypted data for actuating the electronic product or starting the encryption mechanism thereof can be provided to the user.

In summary, the raised portion 30 is ergonomically designed to satisfy different features of use (external factors such as the sliding speed of the finger) of users in general. In this way, when the finger of the user slides to approach the fingerprint sensor 50, it can naturally abut against the first convex surface 31. That is, the first section of the finger can contact the surface of the raised portion 30 and then ride over the fingerprint sensor 50, thereby to enable the fingerprint to be acquired. With the linear contact, the failure rate in capturing the fingerprint can be reduced. In this manner, some external factors such as incorrect positioning and insufficient contact of the finger, which cause an incorrect and incomplete acquisition of fingerprint data and in turn require repeated scanning of the finger can be avoided.

The finger of the user can also slide downwardly and forwardly along the second convex profile surface 32 away from the fingerprint sensor 50. Therefore, it is not necessary to deliberately press the finger against the fingerprint sensor 50 and this second convex surface 32 also enhances the capture efficiency.

In another embodiment, one of the transition portions defined by surfaces 31 and 32 can be dispensed with.

Further, the guide path 20 is optionally formed with an ascending surface 21 or plane thereon, which allows the finger of the user to rest naturally against the surface of the guide path 20 and slide toward the raised portion 30, thereby to increase further the capture efficiency of the fingerprint sensor 50. The different characteristics of use of the population of users can be accommodated without increasing the software efficiency or the area of the fingerprint sensor 50. Also the capture efficiency of the fingerprint sensor 50 can be increased and the failure rate can be reduced. Thereby the cost is minimized.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for fingerprint identification, comprising:
a main body;
a guide path formed on a surface of the main body;
a raised portion extending across the guide path;
a fingerprint sensor provided within a recess in the raised portion and arranged so as to capture the fingerprint of a user's finger as the finger is slid along the guide path and over the raised portion, wherein a transition portion is formed in the guide path adjacent the raised portion which slopes upwardly and towards the raised portion.

2. The apparatus for fingerprint identification according to claim 1, wherein the main body is an electronic information product or a casing.

3. The apparatus for fingerprint identification according to claim 2, wherein the electronic information product is a notebook, mouse, MP3 player, external mobile device, fingerprint reader or computer peripheral.

4. The apparatus for fingerprint identification according to claim 1, wherein one end or both ends of the guide path remote from the raised portion ascend in a direction away from the raised portion.

5. The apparatus for fingerprint identification according to claim 4, wherein one or both of the remove ends have a uniform or progressively increasing inclination in the direction away from the raised portion.

6. The apparatus for fingerprint identification according to claim 4, wherein one or both of the remote ends form a smoothly curved transition portion.

7. The apparatus for fingerprint identification according to claim 1, wherein the guide path is recessed into the surface to form a channel.

8. The apparatus for fingerprint identification according to claim 1, wherein one or both ends of the guide path remote from the raised portion are planar.

9. The apparatus for fingerprint identification according to claim 1, wherein the fingerprint sensor protrudes above the raised portion of the guide path.

10. The apparatus for fingerprint identification according to claim 1, further comprising two transition portions respectively in front or and behind the raised portion.

11. The apparatus for fingerprint identification according to claim 1, wherein the transition portion is longitudinally convex and merges with the raised portion.

12. The apparatus for fingerprint identification according to claim 1, wherein the guide path is provided with a transverse channel which scrapes off at least one of sweat and dirt from a user's finger before the finger rides over the raised portion.
